(19) United States
(12) Patent Application Publication
(10) Pub. No.: US 2021/0160677 A1
(43) Pub. Date: May 27, 2021

(54) ORCHESTRATOR EQUIPMENT IN A CELLULAR TELECOMMUNICATION SYSTEM

(71) Applicant: AIRBUS DEFENCE AND SPACE SAS, TOULOUSE (FR)

(72) Inventors: Franck SCHOLLER, SAINT GERMAIN EN LAYE (FR); Jean-Marc MONTENOT, BALMA (FR)

(21) Appl. No.: 17/045,382

(22) PCT Filed: Apr. 4, 2019
(86) PCT No.: PCT/EP2019/058532

§ 371 Date: Oct. 5, 2020

(30) Foreign Application Priority Data
Apr. 6, 2018 (EP) 1853034

(51) Int. Cl. H04W 4/90; H04W 36/14; H04W 88/16; H04W 12/06; H04W 76/12; H04W 76/50; H04W 48/02

(52) U.S. Cl. CPC H04W 4/90; H04W 36/14; H04W 88/16; H04W 48/02; H04W 76/12; H04W 76/50; H04W 12/06

(57) ABSTRACT

A cellular telecommunications system comprises a radio access portion enabling user equipment to access services of the cellular telecommunications system; and a core network portion comprising a quality of service policy control equipment connected to a gateway via which radio bearers are set up in order to access said services. An orchestrator equipment: receives regular reports from said gateway relating to the radio bearers that are set up; detects the occurrence of a crisis situation; identifies cells affected by the crisis situation; applies, during the crisis situation, crisis situation management rules, by declining to authenticate user equipment for which the crisis situation management rules indicate that access to said services is barred during the crisis situation; and by asking the gateway to close any session set up for user equipment for which the crisis situation management rules indicate that access to said services is barred during the crisis situation.

### CROSS-REFERENCES TO RELATED APPLICATIONS

This application claims the benefit of the International Application No. PCT/EP2019/058532, filed on Apr. 4, 2019, and of the French patent application No. 1853034 filed on Apr. 6, 2018, the entire disclosures of which are incorporated herein by way of reference.

### FIELD OF THE INVENTION

The present invention relates to crisis situation management, such as a situation in which the police and/or civil security services intervene on an incident site, within the context of cellular telecommunications network administration.

### BACKGROUND OF THE INVENTION

In order to carry out their missions, the police or civil security services operate their own telecommunications system and have their own fleet of user equipment deployed on the ground.

In contrast to the circuit-switched model used by previous cellular telecommunications systems, LTE “Long Term Evolution” technology, also called 4G (4th Generation), relies solely on a packet-switched model. Future telecommunications technologies such as LTE-B technology, also called 5G (5th Generation), should follow the same approach.

LTE technology aims to provide connectivity, based on the IP (“Internet Protocol”) protocol, between user equipment UE and a packet data network PDN. Although the terminology “LTE” encompasses an evolution of the UMTS (“Universal Mobile Telecommunications System”) radio access technology called E-UTRAN (“Evolved Universal Terrestrial Radio Access Network”), LTE technology is also accompanied by an evolution of non-radio aspects, called “SAE” (“System Architecture Evolution”), which comprises, in particular, a core network portion called EPC (“Evolved Packet Core”), which is an evolution of the core network introduced in GPRS (“General Packet Radio Service”) technology. Together, LTE and SAE technologies form a cellular telecommunications system called EPS (“Evolved Packet System”).

In this context, the EPS cellular telecommunications system uses a concept of radio bearers, called EPS radio bearers, to route IP traffic between a gateway of the PDN network and any user equipment UE. An EPS radio bearer is a set of coordinated resources dedicated to transporting a stream of IP packets with a predetermined quality of service QoS between said gateway and the user equipment UE. Together, the E-UTRAN radio access portion and the EPC core network portion set up and release radio bearers on the basis of the application needs with regard to user equipment UE present in the EPS cellular telecommunications system.

It should be noted that multiple radio bearers may be set up, and active simultaneously, for one and the same user equipment UE, in order to make available several data streams having different qualities of service QoS or to make it possible to ensure connectivity to various PDN networks. For example, a user equipment UE may be engaged in a VoIP (“Voice over IP”) conversation and simultaneously perform web browsing or downloading in accordance with the FTP (“File Transfer Protocol”) protocol, in which case a first radio bearer provides the quality of service QoS required for the VoIP conversation and a second best-effort radio bearer provides support suitable for web browsing or downloading in accordance with the FTP protocol.

The radio bearers that may be set up in the EPS cellular telecommunications system depend on subscriptions made with telecommunications operators for the user equipment UE for which these radio bearers are intended. The EPS cellular telecommunications system therefore acts on the basis of these subscriptions. There are however situations, referred to here as crisis situations, in which this behavior of the EPS cellular telecommunications system is unsuitable. Such crisis situations are, for example, events requiring a bolstered police presence or even a terrorist attack requiring the joint intervention of the police and civil security services, etc. In these situations, the EPS cellular telecommunications system may be congested by communications or more generally by the use of the services of the EPS cellular telecommunications system that comply with the subscriptions associated with the user equipment UE in question but that do not have priority over the ongoing crisis situation. In such situations, the lack of availability of the EPS cellular telecommunications system may have a significant negative impact on the management of the crisis situation by the police or/and civil security and the resolution thereof.

It is desirable to overcome these various drawbacks from the prior art. It is thus desirable to provide a solution that makes it possible to facilitate the management and resolution of the crisis situation by guaranteeing the availability of the EPS cellular telecommunications system and by proposing to dynamically adapt its services and their capacities to operational constraints. It is also desirable to provide a solution that avoids modifying the equipment forming existing EPS cellular telecommunications system infrastructures.

### SUMMARY OF THE INVENTION

The invention relates to a method for accessing services of a cellular telecommunications system comprising: a radio access portion enabling user equipment to access services of the cellular telecommunications system for which radio bearers have to be set up; and a core network portion comprising a quality of service policy control equipment connected to a gateway via which said radio bearers are set up in order to access said services. The method is such that an orchestrator equipment connected to said gateway performs the following steps: receiving regular reports from said gateway relating to the radio bearers set up in the cellular telecommunications system for the user equipment attached to said gateway; detecting the occurrence of a crisis situation; identifying cells of the cellular telecommunications system affected by the crisis situation; applying, during the crisis situation, crisis situation management rules: by declining to authenticate user equipment for which the crisis situation management rules indicate that access to said services is barred during the crisis situation, when said gateway makes an authentication request for said user equipment to the orchestrator equipment; and by asking the gateway to close any session set up for user equipment for which the crisis situation management rules indicate that access to said services is barred during the crisis situation, when the regular reports indicate that such sessions exist for said user equipment. Management and resolution of the crisis situation are thus facilitated by guaranteeing the availability of the services of the cellular telecommunications system, by virtue of tailored management of the radio bearers and sessions.

According to one particular embodiment, the orchestrator equipment applies the crisis situation management rules during the crisis situation further: by declining to authenticate user equipment for which the crisis situation management rules indicate that attachment to a predefined access point name is barred during the crisis situation, when said gateway makes an authentication request for said user equipment to the orchestrator equipment; and by asking the gateway to close any session set up for user equipment for which the crisis situation management rules indicate that attachment to a predefined access point name is barred during the crisis situation, when the regular reports indicate that such sessions exist for said user equipment. The availability of the services of the cellular telecommunications system is thus increased by managing the attachment to the access point names.

According to one particular embodiment, the orchestrator equipment applies the crisis situation management rules during the crisis situation further by declining to set up said radio bearer of a user equipment when the crisis situation management rules indicate that the quality of service class identifier of said radio bearer is barred during the crisis situation. The availability of the services of the cellular telecommunications system is thus increased by managing the setup of radio bearers by quality of service class.

According to one particular embodiment, the orchestrator equipment applies the crisis situation management rules during the crisis situation further: by asking the gateway to close any radio bearer set up for user equipment for which the crisis situation management rules indicate that a quality of service class identifier is barred, when the regular reports indicate that such sessions exist for said user equipment. The availability of the services of the cellular telecommunications system is thus increased by managing the radio bearers that are already set up by quality of service class.

According to one particular embodiment, the orchestrator equipment additionally applies the crisis situation management rules during the crisis situation: by reducing a quality of service associated with session setups by intercepting and modifying messages exchanged during said session setups between the quality of service policy control equipment and said gateway, when the session setups relate to user equipment for which the crisis situation management rules indicate an authorized quality of service limit. The availability of the services of the cellular telecommunications system is thus increased by managing the session setups by intervening directly in the exchanges between the quality of service policy control equipment and said gateway.

According to one particular embodiment, the orchestrator equipment applies the crisis situation management rules during the crisis situation further: by reducing a quality of service associated with previously set-up radio bearers, by emulating messages transmitted by the quality of service policy control equipment to said gateway, when the sessions relate to user equipment for which the crisis situation management rules indicate an authorized quality of service limit. The availability of the services of the cellular telecommunications system is thus increased by managing the sessions that are already set up by intervening directly with said gateway on behalf of the quality of service policy control equipment.

According to one particular embodiment, the orchestrator equipment applies the crisis situation management rules during the crisis situation further: by reducing a quality of service associated with radio bearer setups by intercepting and modifying messages exchanged during said radio bearer setups between the quality of service policy control equipment and an application function, when the session setups relate to user equipment for which the crisis situation management rules indicate an authorized quality of service limit. The availability of the services of the cellular telecommunications system is thus increased by managing the setup of radio bearers by intervening directly with the quality of service policy control equipment.

According to one particular embodiment, the orchestrator equipment applies the crisis situation management rules during the crisis situation further: by reducing a quality of service associated with previously set-up radio bearers, by emulating messages transmitted by an application function to the quality of service policy control equipment, when said radio bearers relate to user equipment for which the crisis situation management rules indicate an authorized quality of service limit. The availability of the services of the cellular telecommunications system is thus increased by managing the radio bearers that are already set up by intervening directly with said gateway on behalf of the quality of service policy control equipment.

According to one particular embodiment, the orchestrator equipment declares a proxy equipment as domain name server to said gateway, in that the orchestrator equipment serves as authentication and authorization server with the proxy equipment for domain name resolution requests made to the proxy equipment, and in that the orchestrator equipment declines to authenticate or authorize user equipment for which the crisis situation management rules indicate that the domain name to be resolved is barred during the crisis situation for said user equipment. Access to Internet browsing is thus easily controlled.

According to one particular embodiment, the orchestrator equipment implements filtering of at least one level, from: a user equipment identifier filtering table for which at least one rule may be applied during the crisis situation to the user equipment in question; and/or a cell identifier filtering table for which at least one rule may be applied during the crisis situation to the cell in question from among the cells affected by the crisis situation; and/or an access point name filtering table for which at least one rule may be applied during the crisis situation for any connection to the access point name in question; and/or a quality of service class identifier filtering table for which at least one associated rule may be applied during the crisis situation for any radio bearer associated with said quality of service class; and/or an application service filtering table for which at least one associated rule may be applied during the crisis situation for any access to said application service; and/or a quality of service parameter modification table for which at least one associated rule may be applied during the crisis situation for any radio bearer associated with the quality of service parameter in question. The implementation and application of crisis management rules is thus facilitated by using dedicated filtering tables.

According to one particular embodiment, the orchestrator equipment comprises a user interface designed to enable a human operator to declare the occurrence of the crisis situation, to identify the cells of the cellular telecommunications system affected by the crisis situation, to select at least one user equipment or group of user equipment liable to intervene in the affected cells in order to resolve the crisis situation, and to associate sets of crisis situation management rules with said at least one user equipment or group of user equipment. The management of various crisis situation scenarios is thus facilitated.

According to one particular embodiment, the user interface is further designed to enable the human operator to define a set of rules for any other user equipment that does not belong to said at least one user equipment or group of user equipment. The implementation of the rules is thus flexible.

The invention also relates to an orchestrator equipment in the context of accessing services of a cellular telecommunications system comprising: a radio access portion enabling user equipment to access services of the cellular telecommunications system for which radio bearers have to be set up; and a core network portion comprising a quality of service policy control equipment connected to a gateway via which said radio bearers are set up in order to access said services. The orchestrator equipment is intended to be connected to said gateway, and comprises: means for receiving regular reports from said gateway relating to the radio bearers set up in the cellular telecommunications system for the user equipment attached to said gateway; means for detecting the occurrence of a crisis situation; means for identifying cells of the cellular telecommunications system affected by the crisis situation; means for applying, during the crisis situation, crisis situation management rules: by declining to authenticate user equipment for which the crisis situation management rules indicate that access to said services is barred during the crisis situation, when said gateway makes an authentication request for said user equipment to the orchestrator equipment; and by asking the gateway to close any session set up for user equipment for which the crisis situation management rules indicate that access to said is barred during the crisis situation, when the regular reports indicate that such sessions exist for said user equipment.

The invention also relates to a computer program that may be stored on a medium and/or downloaded from a communications network in order to be read by a processor. This computer program comprises instructions for implementing the abovementioned method in any one of its embodiments when said program is executed by said processor. The invention also relates to storage means on which such a computer program is stored.

### BRIEF DESCRIPTION OF THE DRAWINGS

The abovementioned features of the invention, along with others, will become more clearly apparent upon reading the following description of an exemplary embodiment, said description being given with reference to the appended drawings, in which:

FIG. 1 schematically illustrates a cellular telecommunications system in which the present invention is implemented;

FIG. 2 schematically illustrates an example of the hardware architecture of an orchestrator equipment of the cellular telecommunications system;

FIG. 3 schematically illustrates an algorithm for collecting data relating to the use of the cellular telecommunications system;

FIG. 4 schematically illustrates an algorithm for processing the data received within the context of the algorithm of FIG. 3;

FIG. 5 schematically illustrates an algorithm for responding to the occurrence of a crisis situation;

FIG. 6 schematically illustrates an algorithm for managing connections set up via the cellular telecommunications system in a crisis situation;

FIG. 7 schematically illustrates a particular layout in the context of a domain name resolution service;

FIG. 8 schematically illustrates a particular layout of the cellular telecommunications system;

FIG. 9 schematically illustrates first exchanges in the context of a session setup when the particular layout of FIG. 8 is implemented;

FIG. 10 schematically illustrates second exchanges in the context of a session setup when the particular layout of FIG. 8 is implemented.

### DETAILED DESCRIPTION OF THE PREFERRED EMBODIMENTS

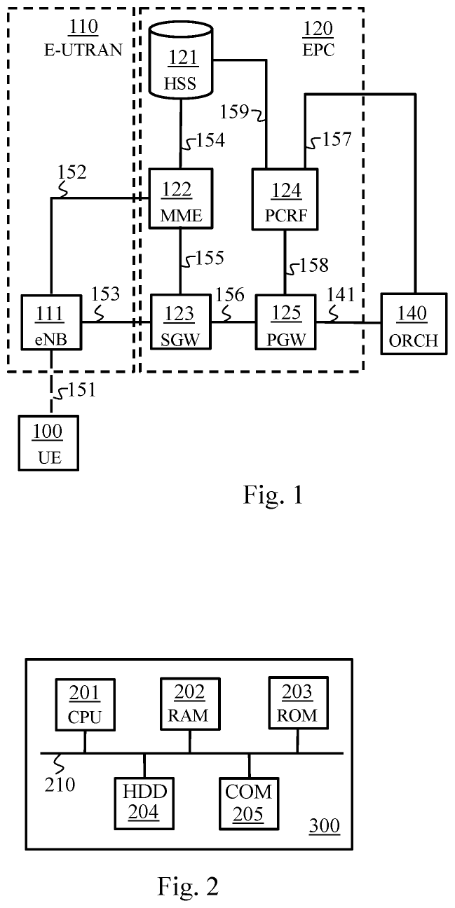

FIG. 1 schematically illustrates an EPS cellular telecommunications system in which the present invention is implemented. The EPS cellular telecommunications system comprises an E-UTRAN radio access portion 110 via which at least one user equipment UE 100, and typically several items of user equipment UE, accesses the services of the EPS cellular telecommunications system, and an EPC core network portion 120 giving access to various PDN networks. The E-UTRAN radio access portion 110 comprises a plurality of base stations, called “eNodeB”, with which user equipment UE communicates via radio in order to access services offered by the EPS cellular telecommunications system. For the sake of simplification, FIG. 1 shows a single eNB base station 111 and a single user equipment UE 100 that are interconnected via the wireless link 151. The user equipment UE 100 accesses the services of the EPS cellular telecommunications system by virtue of a wireless link 151 to the eNB base station 111. The eNB base station 111 is connected to an SGW gateway (“Serving GateWay”) 123 of the EPC core network portion 120 by virtue of a link 153 and to a mobility management entity MME 122 of the EPC core network portion 120 by virtue of a link 152. The EPS cellular telecommunications system typically comprises a plurality of such SGW gateways, a plurality of such eNB base stations being connected to each of these SGW gateways. The EPS cellular telecommunications system typically comprises a plurality of such mobility management entities MME, a plurality of SGW gateways being connected to each of these mobility management entities MME.

The EPC core network portion 120 further comprises at least one PGW gateway (“PDN Gateway”) 125 enabling access to the various PDN networks, a home subscriber server HSS 121, and a PCRF (“Policy Control and Charging Rules Function”) equipment 124 implementing a policy control and charging rules function. The EPS cellular telecommunications system typically comprises a plurality of such PGW gateways, a plurality of such SGW gateways being connected to each of these PGW gateways and a plurality of such PGW gateways being connected to each of these SGW gateways.

The PCRF equipment 124 is responsible for making quality of service QoS policy control decisions, as well as controlling charging functionalities implemented in a PCEF (“Policy Control Enforcement Function”) component of each PGW gateway. The quality of service QoS policy control decisions are thus applied, in accordance with predetermined quality of service QoS policy control rules, by the PCEF component of each PGW gateway in question.

The MME entity 122 is an equipment responsible for the control plane, and more particularly for signaling operations, between the EPC core network portion 120 of the EPS cellular telecommunications system and the user equipment UE connected to the SGW gateways for which the MME entity 122 is responsible.

The HSS server 121 is an equipment for managing a database containing information relating to a profile of each user who has subscribed to the services of the EPS cellular telecommunications system, as well as information relating to said subscription. The HSS server 121, in particular, stores, for each user, information about the PDN networks that said user is authorized to access via his user equipment UE. The HSS server 121 also, in particular, stores dynamic information representative of the MME entity to which said user equipment UE is currently attached. The HSS server 121 may also integrate an authentication center AUC, responsible for generating security and authentication key vectors.

The PGW gateway 125 is also, in particular, responsible for enforcing quality of service QoS policies with regard to guaranteed bit rate GBR radio bearers, and for enabling an online charging system OCS to collect charging data through data streams, on the basis of rules provided by the PCRF equipment 124.

The PGW gateway 125 uses an orchestrator ORCH 140 to allocate IP addresses to the user equipment UE authorized to access the PDN network(s) to which the PGW gateway 125 gives access. The PGW gateway 125 uses the orchestrator equipment ORCH 140 to authenticate said user equipment UE and, in return for successful authentication, the orchestrator equipment ORCH 140 provides an IP address for each user equipment UE in question. As described below, the PGW gateway 125 is configurable, in order to provide said orchestrator equipment ORCH 140 with reports about the ongoing communications in the EPS cellular telecommunications system and notifications about changes occurring in the ongoing communications in the EPS cellular telecommunications system (setup of a new communication, change of cell of a user equipment UE, end of a communication, etc.).

The SGW gateway 123 is responsible for routing the data streams from and to the user equipment UE connected to the eNB base stations under the responsibility of the SGW gateway 123. The SGW gateway 123 serves, in particular, as a local mobility anchor when the user equipment UE 100 migrates from the eNB base station 111 to another eNB base station under the responsibility of the SGW gateway 123, and vice versa.

The orchestrator equipment ORCH 140 is responsible for temporarily modifying the quality of service QoS policy control rules that are applied by the PCEF component of each PGW gateway in question, so as to adapt the behavior of the EPC core network portion 120 to a crisis situation.

In one particular embodiment, the orchestrator equipment ORCH 140 is also responsible for indicating to the PGW gateway 125 the domain name server, e.g., of DNS (“Domain Name Service”) type, to which to refer in order to perform domain name resolutions and possibly reverse resolutions. The orchestrator equipment ORCH 140 preferably tells the PGW gateway 125 to refer, for domain name resolutions and possibly reverse resolutions, to a proxy equipment, as described below with reference to FIG. 7.

In the diagram of FIG. 1, the SGW gateway 123 is connected to the PGW gateway 125 by virtue of a link 156. The SGW gateway 123 is connected to the MME entity 122 by virtue of a link 155. The MME entity 122 is connected to the HSS server 121 by virtue of a link 154. The PGW gateway 125 is connected to the PCRF equipment 124 by virtue of a link 158. The PCRF equipment 124 is connected to the HSS server 121 by virtue of a link 159.

The PGW gateway 125 is further connected to the equipment to the orchestrator equipment ORCH 140 by virtue of a link 141.

The PCRF equipment 124 may further be connected to an AF (“Application Function”) equipment 130, also called IMS (“IP Multimedia Subsystem”) that implements an application function. In the diagram of FIG. 1, the orchestrator equipment ORCH 140 is seen, in a particular embodiment, as an AF equipment by the PCRF equipment 124 and is connected thereto via a link 157.

In the context of LTE technology, the interfaces (as well as the applicable message formats)—also called “reference points” in the LTE technology terminology—between the various elements forming the EPS cellular telecommunications system are standardized. In particular:
the interface between the PGW gateway 125 and the PCRF equipment 124 is called Gx and is defined in the 3GPP TS 23.203 specifications: “Policy and Charging Control Architecture” and 3GPP TS 29.212 “Policy and Charging Control (PCC); Reference Points”;
the interface between the PCRF equipment 124 and the orchestrator equipment ORCH 140 is called Rx and is defined in the 3GPP TS 23.203 specifications: “Policy and Charging Control Architecture” and 3GPP TS 29.214 “Policy and Charging Control over Rx Reference Point”; and
the interface between the PGW gateway 125 and the orchestrator equipment ORCH 140 is called SGi and is defined in the 3GPP TS 29.061 specifications “Interworking between the Public Land Mobile Network (PLMN) supporting packet based services and Packet Data Networks (PDN)”.

It should be noted that the Gx, Rx and SGi interfaces are based on the DIAMETER protocol, as specified in the normative document RFC 3588, which was defined to replace the RADIUS (“Remote Authentication Dial-In User Service”) protocol, as specified in normative documents RFC 2865 and RFC 2866, in AAA (“Authentication, Authorization, Accounting/Auditing”) infrastructures.

It should also be noted that the links between the E-UTRAN radio access portion 110 and the EPC core network portion 120, as well as the links within the EPC core network portion 120, and the links between the EPC core network portion 120 and the orchestrator equipment ORCH 140 are logic links. This means that network equipment, such as routers or switches, is typically present on these links in order to transmit IP packets in which any exchanged message is encapsulated.

FIG. 2 schematically illustrates an example of the hardware architecture of the orchestrator equipment ORCH 140.

The orchestrator equipment ORCH 140 then includes, connected by a communication bus 210: a processor or CPU (“Central Processing Unit”) 201; a random access memory RAM 202; a read-only memory ROM 203; a storage unit 204, such as an HDD (“Hard Disk Drive”), or a storage medium reader, such as an SD (“Secure Digital”) card reader; and at least one communication interface COM 205 configured so as to enable the orchestrator equipment ORCH 140 to communicate, in particular, within the EPS cellular telecommunications system.

The processor 201 is capable of executing instructions loaded into the random access memory RAM 202 from the read-only memory ROM 203, or from an external memory, or from a storage medium, or from a communications network. When the orchestrator equipment ORCH 140 is powered on, the processor 201 is capable of reading the instructions from the random access memory RAM 202 and executing them. These instructions form a computer program that causes the processor 201 to implement all or some of the algorithms and steps described below.

All or some of the algorithms and steps described below may thus be implemented in software form by executing a set of instructions by way of a programmable machine, for example a DSP (“Digital Signal Processor”) or a microprocessor, or be implemented in hardware form by way of a machine or a dedicated component (“chip”) or a set of dedicated components (“chipset”), such as for example an FPGA (“Field-Programmable Gate Array”) component or an ASIC (“Application-Specific Integrated Circuit”) component. Generally speaking, the orchestrator equipment ORCH 140 comprises electronic circuitry configured so as to implement the algorithms and steps described below.

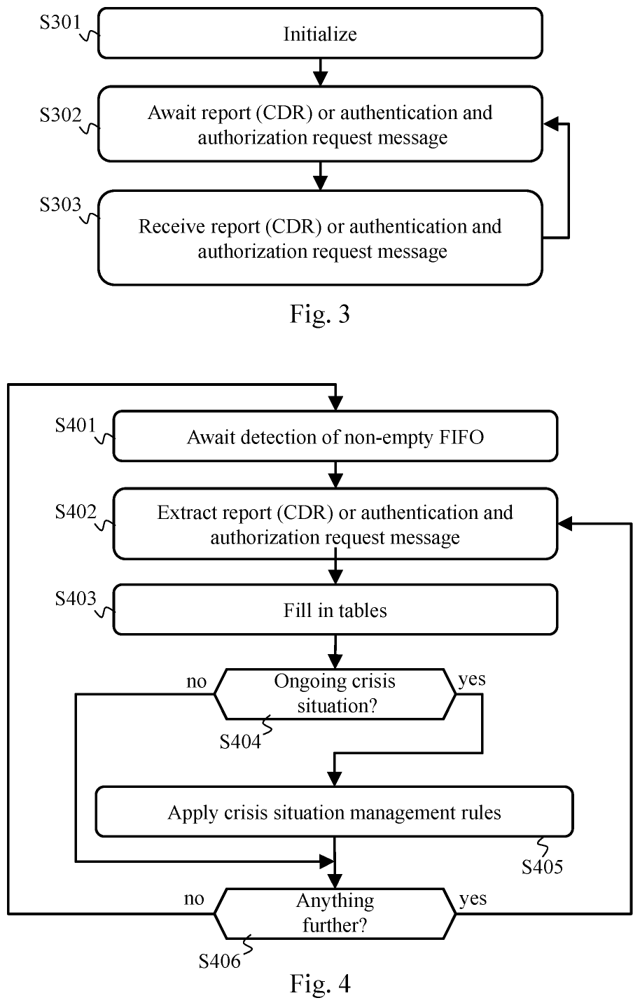

FIG. 3 schematically illustrates an algorithm for collecting data relating to the use of the cellular telecommunications system. The algorithm of FIG. 3 is implemented by the orchestrator equipment ORCH 140. It is considered in FIG. 3 that the PGW gateway 125 is preconfigured so as to transmit periodic CDR (“Charging Data Record”) reports to the orchestrator equipment ORCH 140 relating to each session set up via the PGW gateway 125. It is recalled that each session comprises at least one radio bearer, specifically a default radio bearer (“default EPS bearer”) that is implemented during a registration procedure for the user equipment UE in question, and possibly one or more dedicated radio bearers (“dedicated EPS bearer”). In addition, the PGW gateway 125 is preconfigured so as to transmit a CDR report of each modification of use of a said session (for example, in the case of a change of cell by a user equipment UE). The transmission periodicity of the CDR reports is also preconfigured.

The orchestrator equipment ORCH 140 is thus informed of each session set up via the PGW gateway 125 and of the user equipment UE involved in said session. The orchestrator equipment ORCH 140 is thus informed of any communication activity in any cell managed by the PGW gateway 125.

In addition, the PGW gateway 125 is configured so as to use the orchestrator equipment ORCH 140 as AAA server when creating a session and ending sessions. Thus, when the SGW gateway 123 requests session creation from the PGW gateway 125, the PGW gateway 125 asks the orchestrator equipment ORCH 140 to authenticate the user equipment UE in question and to validate, or not validate, the session creation for said user equipment UE. The message exchanges described in paragraph 16 of the abovementioned 3GPP TS 29.061 specifications are preferably used. The orchestrator equipment ORCH 140 is then responsible for allocating an IP address for each user terminal UE, as already mentioned.

In a step S301, the orchestrator equipment ORCH 140 is initialized, for example, by implementing the AAA services and opening the associated ports.

In a step S302, the orchestrator equipment ORCH 140 waits to receive a CDR report from the PGW gateway 125. According to the 3GPP TS 29.061 specifications, such CDR reports are transmitted in Accounting-Request(start), Accounting-Request(stop) or Accounting-Request(interim) messages. The orchestrator equipment ORCH 140 may also be required to receive authentication and authorization request messages, in particular Access-Request messages, as AAA server.

In a step S303, the orchestrator equipment ORCH 140 receives a CDR report or an authentication and authorization request message from the PGW gateway 125. The orchestrator equipment ORCH 140 places the CDR report or the authentication and authorization request message, received in step S302, in a FIFO (“First-In First-Out”) buffer memory. A dedicated process is then responsible for unstacking the CDR reports or messages stored in the FIFO buffer memory, as described below with reference to FIG. 4. In one variant embodiment, the orchestrator equipment ORCH 140 may directly process the CDR reports or messages when they are received. One advantage of using a FIFO memory is that it enables a certain asynchronism between the reception of the CDR reports or messages and processing thereof. In another variant embodiment, the orchestrator equipment ORCH 140 may process the authentication and authorization request messages when they are received, and place the CDR reports in the FIFO buffer memory for subsequent asynchronous processing by the dedicated process.

The orchestrator equipment ORCH 140 then waits to receive a new CDR report, or a new authentication and authorization request message, from the PGW gateway 125. Step S302 is thus repeated.

FIG. 4 schematically illustrates an algorithm for processing the data received within the context of the algorithm of FIG. 3. The algorithm of FIG. 4 is implemented by the orchestrator equipment ORCH 140.

In a step S401, the orchestrator equipment ORCH 140 is waiting for the FIFO buffer memory, introduced with reference to FIG. 3, to not be empty.

In a step S402, the orchestrator equipment ORCH 140 detects that the FIFO buffer memory is not empty, and extracts a CDR report or an authentication and authorization request message therefrom.

In a step S403, the orchestrator equipment ORCH 140 fills in management tables based on the data contained in the CDR report, or authentication and authorization request message, extracted in step S402.

The orchestrator equipment ORCH 140 thus comprises management tables that are dynamically updated based on the data received from the PGW gateway 125.

Thus, in one particular embodiment, the orchestrator equipment ORCH 140 comprises a description table of the radio bearers set up in the EPS cellular telecommunications system, called BEARERS-DESC. The table BEARERS-DESC thus comprises a descriptor for each radio bearer, which comprises at least: a radio bearer identifier BEARER-ID identifying said radio bearer, a session identifier SESSION-ID with which the radio bearer is associated, a quality of service class identifier QCI (“QoS Class Identifier” where “QoS” stands for “Quality of Service”) associated with said radio bearer, information on the authorized maximum bit rate MBR via said radio bearer, and ARP (“Allocation Retention Priority”) priority information associated with said radio bearer. Other information may supplement said descriptor, such as for example information on the guaranteed bit rate GBR via said radio bearer, information on the volume of data transported via said radio bearer, etc.

The orchestrator equipment ORCH 140 also comprises a session description table, called SESSIONS-DESC. The table SESSIONS-DESC thus comprises a descriptor for each session, which comprises at least: a session identifier SESSION-ID identifying said session, a cell identifier CELL-ID of the cell in which the user equipment UE in question is located, and an IMSI (“International Mobile Subscriber Identity”) subscription identifier. Other information may supplement said descriptor, such as for example information on the radio access technology RAT used by the user equipment UE in question, an IP address allocated to the user equipment UE for which the session has been set up, an access point name APN of the packet data network PDN with which said session was set up, etc.

The orchestrator equipment ORCH 140 may further comprise static management tables providing for example a description of the structure of the EPS cellular telecommunications system, a description of the network resources made available by the EPS cellular telecommunications system, and a list of IMSI subscription identifiers obtained from the home subscription server HSS 121.

In a step S404, the orchestrator equipment ORCH 140 checks whether or not there is currently a crisis situation. If this is the case, a step S405 is performed; if not, a step S406 is performed.

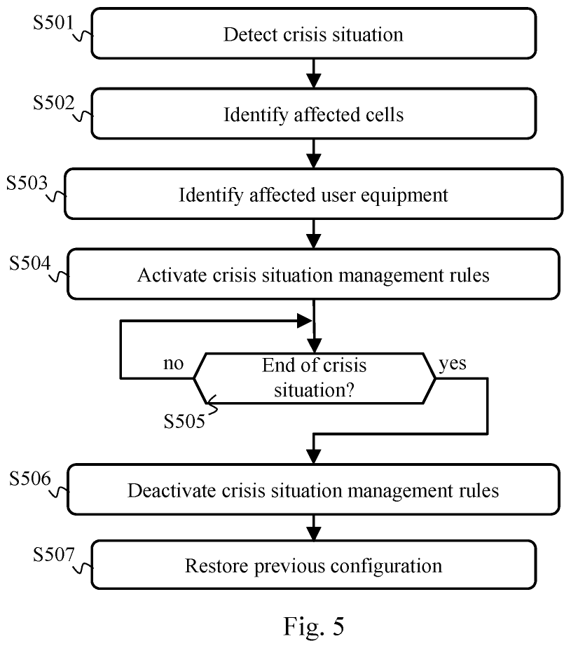

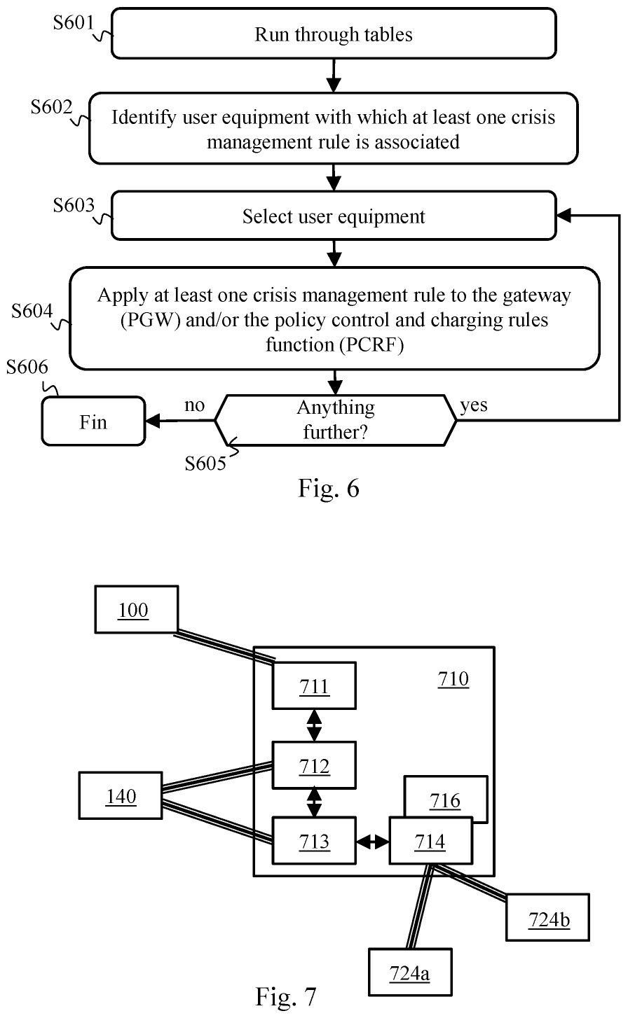

In step S405, the orchestrator equipment ORCH 140 applies crisis situation management rules. These rules define a temporary behavior to be adopted by the EPS cellular telecommunications system with regard to setting up and modifying sessions and radio bearers during the crisis situation. This aspect is detailed below with reference to FIGS. 5 and 6.

In step S406, the orchestrator equipment ORCH 140 checks whether the FIFO buffer memory contains other data. If this is the case, step S402 is repeated; if not, step S401 is repeated.

FIG. 5 schematically illustrates an algorithm for responding to the occurrence of a crisis situation. The algorithm of FIG. 5 is implemented by the orchestrator equipment ORCH 140.

In a step S501, the orchestrator equipment ORCH 140 detects the occurrence of a crisis situation.

Such a crisis situation is triggered for example by the occurrence of a fire, or a gas leak, or a terrorist attack, or any other incident that requires the intervention of specific operational services (police, civil security services, military, etc.) with specific communication needs for which it is necessary to adapt the behavior of the EPS cellular telecommunications system for the duration of the crisis situation.

The occurrence of the crisis situation may be signaled to the orchestrator equipment ORCH 140 by a human operator via a human-machine interface of the orchestrator equipment ORCH 140, for example via a dedicated graphical user interface GUI. The occurrence of the crisis situation may be signaled to the orchestrator equipment ORCH 140 by a sensor connected, for example via the Internet, to the orchestrator equipment ORCH 140. For example, the occurrence of a fire may be signaled to the orchestrator equipment ORCH 140 by a smoke detector connected to the orchestrator equipment ORCH 140 via the Internet or an LPWAN (“Low-Power Wide Area Network”) network, for example using LoRa technology.

In a step S502, the orchestrator equipment ORCH 140 identifies which cells of the EPS cellular telecommunications system are affected by the crisis situation.

An indication of each cell of the EPS cellular telecommunications system affected by the crisis situation may be provided by a human operator via a dedicated graphical user interface GUI of the orchestrator equipment ORCH 140. For example, the graphical user interface GUI displays a location where the incident that triggered the crisis situation occurred on a map, the map also showing the position of the base stations, e.g., eNodeB, of the EPS cellular telecommunications system and their respective radio ranges. The human operator then selects the cells that surround the location where said incident has occurred within a given radius. Automatic selection of the cells in question is possible by selecting the cells of the EPS cellular telecommunications system for which the position of the base stations, e.g., eNodeB, is located at a distance less than a predefined threshold with respect to the location where said incident has occurred. The number of cells affected may differ depending on the type of incident that triggered the crisis situation.

In a step S503, the orchestrator equipment ORCH 140 identifies which user equipment UE is affected by the crisis situation. In one particular embodiment, the orchestrator equipment ORCH 140 identifies which user equipment UE should have priority in order to benefit from certain services, so as to make it possible to facilitate resolution of the crisis situation on the ground.

In one particular embodiment, the orchestrator equipment ORCH 140 accesses, in a database, a list of identifiers of user equipment UE, e.g., IMSI subscription identifiers, used by the police and/or civil security services who need to intervene at the site of the incident. In another particular embodiment, the orchestrator equipment ORCH 140 classifies the user equipment UE into predefined groups, each predefined group being associated with crisis situation management rules that are specific thereto. For example, the orchestrator equipment ORCH 140 has: a first class that corresponds to a first list of user equipment UE liable to be used by the police, with which a first set of rules is associated; and a second class that corresponds to a second list of user equipment UE liable to be used by civil security forces, with which a second set of rules is associated; and a third class that groups together all of the other user equipment UE, with which a third set of rules is associated.

In a step S504, the orchestrator equipment ORCH 140 activates crisis situation management rules. These crisis situation management rules define an action plan to be applied by the EPS cellular telecommunications system with regard to user equipment UE present in the cells identified in step S502.

In one particular embodiment, a human operator selects a crisis situation profile via a dedicated graphical user interface GUI of the orchestrator equipment ORCH 140, thereby selecting a predefined set of crisis situation management rules. For example, considering that the crisis situation is triggered by a terrorist act, the human operator selects a crisis situation profile that corresponds to a terrorist act scenario and the predefined set of crisis situation management rules resulting therefrom defines:
that, for the police, for whom the identifiers of the terminals that are used are known in step S503, the voice service is authorized with a guaranteed quality of service QoS level, while access to non-critical services such as Internet browsing is barred;
that, for special intervention forces, for whom the identifiers of the terminals that are used are known in step S503, the voice and video services are authorized with a guaranteed quality of service QoS level, as well as access to one or more business applications, while access to non-critical services such as Internet browsing is barred;
that, for civil security forces, for whom the identifiers of the terminals that are used are known in step S503, the voice service is authorized with a guaranteed quality of service QoS level and access to non-critical services such as Internet browsing is barred; and
that, for IoT (“Internet of Things”) connected object sensors, whose identifiers are known in step S503, the data service is authorized with a guaranteed quality of service QoS level (for example with regard to gas presence sensors in the event of a sarin gas attack); and
that, for other users (whose terminal identifiers are all those that have not been explicitly listed in step S503), voice services are authorized with a non-guaranteed quality of service QoS level, and access to non-critical services such as the data service and Internet browsing is barred.

The rules presented above are illustrative, and different behavior of the EPS cellular telecommunications system may be predefined depending on the crisis situation scenario that is encountered. In addition, in one particular embodiment, the crisis situation management rules may be modified dynamically by the human operator, so as to adapt them to particular features of the crisis situation that is encountered.

As detailed below, applying these rules involves intervention of the orchestrator equipment ORCH 140 so as to ensure that said rules are complied with. The application of said rules may be different depending on the implementation context of the orchestrator equipment ORCH 140, and more particularly depending on the communication means that the orchestrator equipment ORCH 140 has, in particular, for communicating with the PCRF equipment 124. For example, the link 158 between the PGW gateway 125 and the PCRF equipment 124 may or may not be made accessible to the orchestrator equipment ORCH 140 for interception and possible modification of messages transiting therethrough.

In order to be able to apply these rules to the EPS cellular telecommunications system on the basis of the data returned by the PGW gateway 125, the orchestrator equipment ORCH 140 preferably implements filtering tables. Some preferred examples of filtering tables are presented below.

The orchestrator equipment ORCH 140 creates a filtering table, called IMSI-FILTR, for filtering by user equipment identifier UE for which at least one associated rule may be applied during the crisis situation. The table IMSI-FILTR thus comprises at least one descriptor for each user equipment UE identified in step S503, which includes: an identifier of said user equipment UE, for which at least one associated rule may be applied during the crisis situation. The descriptor may further include an organization identifier (e.g., police, civil security services, technical services, etc.) to which said user equipment UE belongs. For example, such a descriptor indicates that the user equipment UE cannot set up a communication session.

The orchestrator equipment ORCH 140 creates a filtering table, called CELL-FILTR, for filtering by cell identifier for which at least one associated rule may be applied during the crisis situation. The table CELL-FILTR thus comprises at least one descriptor for each cell identified in step S503, which includes: an identifier of the cell, for which at least one associated rule may be applied during the crisis situation. For example, such a descriptor indicates that any user equipment UE in said cell cannot access a particular service of the EPS cellular telecommunications system.

The orchestrator equipment ORCH 140 creates a filtering table, called APN-FILTR, for filtering by access point name APN for which at least one associated rule may be applied during the crisis situation. The table APN-FILTR thus comprises at least one descriptor for each access point name APN for which at least one associated rule should be applied during the crisis situation. For example, such a descriptor indicates that user equipment UE seeking to connect to a particular access point name APN should be declined authentication during the crisis situation and that user equipment UE already connected to a particular access point name APN should be disconnected.

The orchestrator equipment ORCH 140 creates a filtering table, called QCI-FILTR, for filtering by quality of service class identifier QCI for which at least one associated rule may be applied during the crisis situation. The table QCI-FILTR thus comprises at least one descriptor for each quality of service class identifier QCI for which at least one associated rule may be applied during the crisis situation. For example, such a descriptor indicates that the radio bearers associated with a particular quality of service class QCI, or with a higher class, should be declined or closed during the crisis situation.

The orchestrator equipment ORCH 140 creates a filtering table, called APP-FILTR, for filtering by application service for which at least one associated rule may be applied during the crisis situation. The table APP-FILTR thus comprises at least one descriptor for each application service (e.g., access to a specific URL (“Uniform Resource Locator”) and associated domain name resolution) for which at least one associated rule may be applied during the crisis situation. For example, such a descriptor indicates that a particular domain name is accessible during the crisis situation or conversely that it is accessible only to user equipment UE associated with a particular organization identifier (e.g., the police, civil security services, technical services, etc.).

The orchestrator equipment ORCH 140 creates a table, called QOS-MOD, for modifying quality of service parameters. The table QOS-MOD thus comprises at least one descriptor for each quality of service level for which at least one associated rule may be applied during the crisis situation. For example, such a descriptor indicates that a particular quality of service QoS level should be lowered to a default quality of service QoS level.

Other filtering tables may be implemented in order to facilitate filtering of CDR reports and authentication and authorization request messages, and possibly domain name resolution requests.

Filtering tables may be combined. The rules may thus be defined by combining several filtering levels using filtering tables. For example, user equipment UE IMSI identifier filtering and cell identifier CELL-ID filtering makes it possible to decline the setup of sessions or to close ongoing sessions for the user equipment UE identified for one or more predetermined cells from among the cells identified in step S502. Outside of said predetermined cell or cells, this same user equipment UE is authorized to set up a communication session among the cells identified in step S502.

By extension of the above example, it is possible to combine cell identifier CELL-ID filtering with access point name APN filtering or with quality of service class identifier QCI filtering or with application APP filtering or with quality of service QoS modification filtering in order to limit the application of the respective filtering rules to any user equipment UE present in one or more predetermined cells from among the cells identified in step S502. It is also possible to combine user equipment UE IMSI identifier filtering with access point name APN filtering or with quality of service class identifier QCI filtering or with application APP filtering or with quality of service QoS modification filtering in order to limit the application of the respective rules to one or more predetermined items of user equipment UE regardless of the cell from among the cells identified in step S502.

According to another embodiment, it is also possible to define rules of three filtering levels, such as for example cell identifier CELL-ID filtering, access point name APN filtering and user equipment UE IMSI identifier filtering, thereby making it possible to apply APN filtering only to a predetermined user equipment UE in one or more given cells from among the cells identified in step S502. In a manner identical to the rules defining two distinct filtering levels, it is possible to combine cell identifier CELL-ID filtering and user equipment UE IMSI identifier filtering with application APP filtering or with quality of service class identifier QCI filtering or with quality of service QoS modification filtering in order to limit the application of the respective rules to a predetermined user equipment UE in one or more given cells from among the cells identified in step S502.

Preferably, these filtering tables are created from models (templates) stored in the database, which have been established beforehand according to the type of crisis situation (fire, attack, gas leak, etc.).

The implementation of the crisis situation management rules entails, for the duration of the crisis situation, the involvement of the orchestrator equipment ORCH 140 in the management of the connections set up via the EPS cellular telecommunications system. This aspect is detailed below with reference to FIG. 6.

In a step S505, the orchestrator equipment ORCH 140 checks whether or not the crisis situation has ended. For example, the end of the crisis situation may be signaled to the orchestrator equipment ORCH 140 by a human operator via a dedicated graphical user interface GUI of the orchestrator equipment ORCH 140. If the crisis situation has ended, a step S506 is performed; if not, step S505 is repeated, for example after the expiry of a predefined time delay.

FIG. 6 schematically illustrates an algorithm for managing connections set up via the EPS cellular telecommunications system in a crisis situation. The algorithm of FIG. 6 is implemented by the orchestrator equipment ORCH 140 and is triggered on updating of the abovementioned management tables (see step S403).

In a step S601, the orchestrator equipment ORCH 140 analyzes the data and messages received from the PGW gateway 125. In other words, the orchestrator equipment ORCH 140 runs through the abovementioned management tables.

In a step S602, the orchestrator equipment ORCH 140 identifies, from among the connections described in the management tables, the user equipment UE for which at least one crisis situation management rule is applicable.

In a step S603, the orchestrator equipment ORCH 140 selects a user equipment UE from among the user equipment UE identified in step S602.

In a step S604, the orchestrator equipment ORCH 140 applies each crisis situation management rule that has been defined for the user equipment UE that was selected in step S603. More particularly, the orchestrator equipment ORCH 140 refers to the filtering tables in order to determine which rule to apply for which user equipment UE.

When the orchestrator equipment ORCH 140 is informed by the PGW gateway 125 that a connection has been set up for such user equipment UE, the orchestrator equipment ORCH 140 checks whether or not a crisis situation management rule should be applied for said connection.

According to a first example, when the orchestrator equipment ORCH 140 detects that a user equipment UE has set up a session in a cell affected by the crisis situation, the orchestrator equipment ORCH 140 asks the PGW gateway 125 to close said session. To this end, the orchestrator equipment ORCH 140 may ask the PGW gateway 125 to close the default radio bearer for said session, which has the effect of closing all of the radio bearers for said session.

According to a second example, when the orchestrator equipment ORCH 140 detects that a user equipment UE has set up a session, in a cell affected by the crisis situation, with an access point name APN that is barred therefor, the orchestrator equipment ORCH 140 asks the PGW gateway 125 to close the radio bearer in question.

According to a third example, when the orchestrator equipment ORCH 140 detects that a user equipment UE has set up a radio bearer in a cell affected by the crisis situation, the orchestrator equipment ORCH 140 checks that said radio bearer is associated with an expected quality of service class identifier QCI. If said radio bearer is associated with a barred quality of service class identifier QCI, the orchestrator equipment ORCH 140 asks the PGW gateway 125 to close the radio bearer in question. If said radio bearer is associated with an inappropriate quality of service class identifier QCI, the orchestrator equipment ORCH 140 forces adaptation of the quality of service class QCI so that said radio bearer is associated with the expected quality of service class identifier QCI.

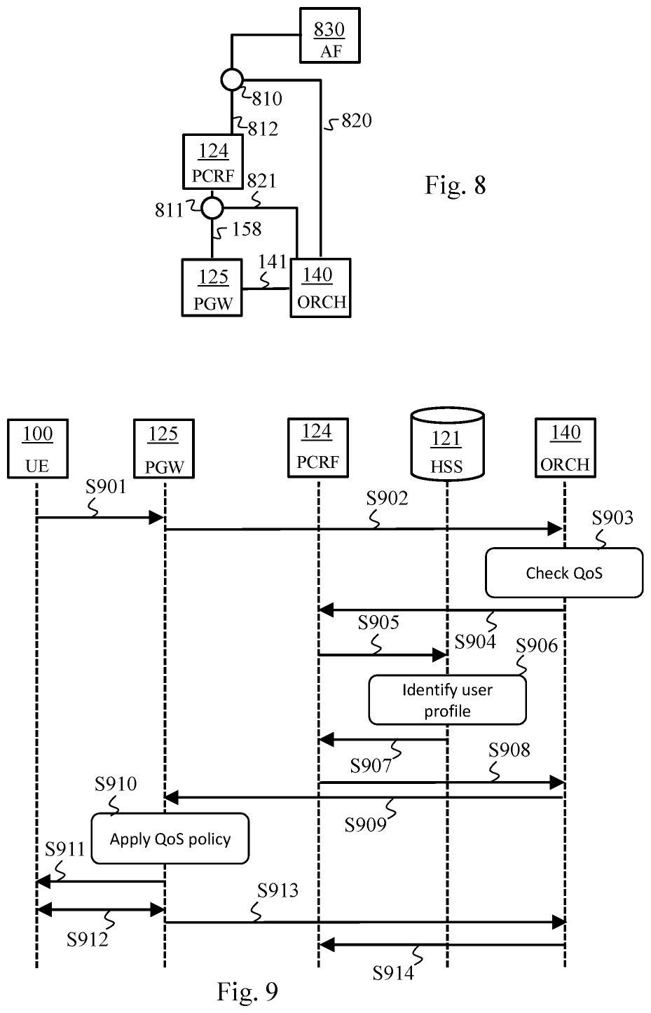

According to a fourth example, when the orchestrator equipment ORCH 140 detects that a user equipment UE has set up a session in a cell affected by the crisis situation and that a crisis situation management rule stipulates that specific quality of service QoS constraints are applied, the orchestrator equipment ORCH 140 guarantees to the PGW gateway 125 and/or the PCRF equipment 124 that said quality of service QoS constraints are applied. These constraints may be taken into account when the session is set up or during the session, as detailed below with reference to FIGS. 8 to 10.

In one particular embodiment, the orchestrator equipment ORCH 140 may also prevent the setup of certain sessions. For example, when the management rules define that a session setup is barred with such an access point APN for a user equipment UE under consideration, the orchestrator equipment ORCH 140 may return a negative response to any authentication and authorization request message in relation to said access point APN on behalf of said user equipment UE.

In one particular embodiment, two application cases are distinguished for crisis situation management rules relating to a cell or a group of cells: during attachment of a user equipment UE in question; and after attachment, upon detection of mobility via reception of CDR reports.

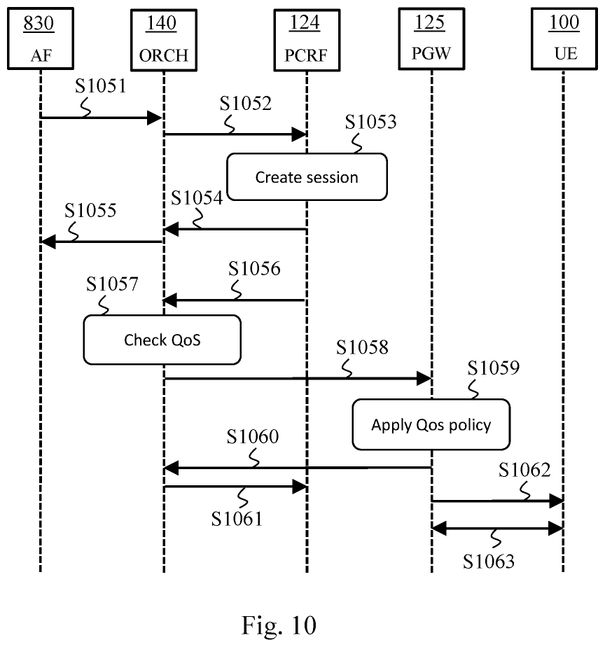

In the case of attachment, the orchestrator equipment ORCH 140 applies one or more rules from among said crisis situation management rules to the authentication of said user equipment UE. The orchestrator equipment ORCH 140 may decline the authentication of said user equipment UE via the link 141 upon an authentication and authorization request message in connection with an access point APN which, according to said crisis situation management rules, is barred from being accessed by the user equipment UE in question for the duration of the crisis situation. The orchestrator equipment ORCH 140 may also decline the authentication of said user equipment UE via the link 141 when the user equipment UE in question does not have access rights, according to said crisis situation management rules, to the EPS cellular telecommunications system for the duration of the crisis situation. In addition, if the crisis situation management rules define that the radio bearers for the user equipment UE in question are limited in terms of quality of service QoS, the orchestrator equipment ORCH 140 may intercept and modify quality of service QoS features (guaranteed bandwidth, etc.) when sessions or radio bearers are set up, by intercepting messages transiting on the link 158, as described below with reference to FIGS. 8 and 9. The same would apply when setting up radio bearers using an application function AF, by intercepting messages transiting between said application function and the PCRF equipment 124, as described below with reference to FIGS. 8 and 10.

In the case of mobility detection (“handover”), the orchestrator equipment ORCH 140 applies one or more rules from among said crisis situation management rules for previously set-up sessions (for example, set up in a cell not affected by the crisis situation). The orchestrator equipment ORCH 140 may detect, in a CDR report, that a user equipment UE is in a relationship with an access point APN that, according to said crisis situation management rules, is barred from being accessed by the user equipment UE in question for the duration of the crisis situation. The orchestrator equipment ORCH 140 may then ask the PGW gateway 125, via the link 141, to close the session in question. The orchestrator equipment ORCH 140 may do the same when the user equipment UE in question does not have access rights, according to said crisis situation management rules, to the EPS cellular telecommunications system for the duration of the crisis situation. In addition, if the crisis situation management rules define that the radio bearers for the user equipment UE in question are limited in terms of quality of service QoS, the orchestrator equipment ORCH 140 may emulate a quality of service QoS reduction request from the PCRF equipment 124 to the PGW gateway 125. This aspect is discussed below with FIG. 9. As a variant, the orchestrator equipment ORCH 140 may emulate a quality of service QoS reduction request from an application function to the PGW gateway 125 via the link 157. This aspect is discussed below with FIG. 10.

Numerous crisis situation management rules may thus be defined and applied, by using the link 141 to decline authentication or close radio bearers, and possibly by using emulations of sending messages to the PGW gateway 125 by the PCRF equipment 124 via the link 158 or through emulations of sending messages to the PCRF equipment 124 by an application function AF via the link 157 or else by intercepting messages between the PGW gateway 125 and the PCRF equipment 124 or between an application function AF and the PCRF equipment 124. In addition, the orchestrator equipment ORCH 140 may supplement its actions in a crisis situation by virtue of a particular layout within the context of a domain name resolution service, as described below with reference to FIG. 7.

In a step S605, the orchestrator equipment ORCH 140 checks whether or not all of the user equipment UE identified in step S602 has been processed. If there is at least one other item of user equipment UE identified in step S602 to be processed, step S603 is repeated by selecting another user equipment UE from among the user equipment UE identified in step S602; if not, the algorithm of FIG. 6 is ended in a step S606.

FIG. 7 schematically illustrates a particular layout in the context of a domain name resolution and possibly reverse resolution service.

FIG. 7 thus schematically illustrates a proxy equipment 710 suitable for offering DNS domain name resolution services, and preferably reverse resolution. The proxy equipment 710 is thus designed to provide, in response to a domain name resolution request, an IP address corresponding to a domain name contained in said request. The equipment 110 may also be designed to provide an associated domain name in response to a request to identify an IP address contained in said request (i.e. to a reverse resolution request). The equipment 710 is designed to receive requests, for example DNS requests, from client devices (such as the user equipment UE 100), in order to perform domain name resolutions. The proxy equipment 710 is designed to receive requests, for example DNS requests, from client devices (such as the user equipment UE 100), in order to perform reverse resolutions. To this end, each client device liable to use the services offered by the proxy equipment 710 is configured beforehand such that the IP address of the proxy equipment 710 is indicated as the server IP address to be contacted for domain name resolutions and reverse resolutions. Thus, in the DNS framework, the proxy equipment 710 is declared as DNS server to said client devices.

The exchanges between the proxy equipment 710 and each client device (such as the user equipment UE 100) are preferably performed via a secure tunnel, but may also be performed in the open.

The proxy equipment 710 comprises a client interface unit 711, also called Front-End Unit. The client interface unit 711 is responsible for receiving requests from the client devices and for providing any responses to said requests. The client interface unit 111 is preferably responsible for performing filtering in order to check that the received request is correctly formatted, and to do so, in particular, in order to counter any malicious tunneling attempt, e.g., DNS tunneling or DoS (Denial of Service) attacks or DDoS (Distributed Denial of Service) attacks. The client interface unit 711 is responsible for triggering authentication operations for the client devices that respectively transmitted the received requests.

The proxy equipment 710 also comprises an authentication unit 712 responsible for coordinating said authentication operations. To this end, the proxy equipment 710 uses an external authentication server that happens to be the orchestrator equipment ORCH 140. The orchestrator equipment ORCH 140 then serves to authenticate the client device that transmitted a domain name resolution or reverse resolution request. The crisis situation management rules may define that, in a crisis situation, a particular user equipment UE located in a cell affected by the crisis situation should be declined access to Internet browsing; in which case the orchestrator equipment ORCH 140 may decline authentication of the client device that transmitted a domain name resolution or reverse resolution request. The exchanges between the authentication unit 712 and the orchestrator equipment ORCH 140 are preferably performed via a secure tunnel, but may also be performed in the open. These exchanges are in accordance for example with the RADIUS (Remote Authentication Dial-In User Service, as defined in the normative documents RFC 2865 and RFC 2866) protocol, or with the Diameter protocol (as defined in the normative document RFC 3588), or with the TACACS+(Terminal Access Controller Access-Control System Plus) protocol, or with the LDAP (Lightweight Directory Access Protocol, as defined in the normative documents RFC 1777 and RFC 2251) protocol. The authentication unit 712 is also responsible for triggering authorization operations with regard to client devices that respectively transmitted the received requests.

The proxy equipment 710 also comprises an authorization unit 713 responsible for coordinating said authorization operations. The authorization operations aim to ensure that the client device (such as the user equipment UE 100), or the user of said client device, only accesses the resources to which said client device or said user actually has access rights. These authorization operations thus serve to check, for each domain name resolution request authenticated by the authentication unit 712, whether the client device that transmitted said request, or the user of said client device, actually has access rights to the resources of said domain name. To this end, the proxy equipment 710 uses the orchestrator equipment ORCH 140 as external authorization server. The exchanges between the authorization unit 713 and the orchestrator equipment ORCH 140 are preferably performed via a secure tunnel, but may also be performed in the open. These exchanges are for example in accordance with the RADIUS protocol, or with the Diameter protocol, or with the TACACS+ protocol. The authentication unit 712 is also responsible for triggering domain name resolution operations, and preferably reverse resolution operations (depending on the request received from the client device).

The proxy equipment 710 also comprises a domain name resolution unit 714 responsible for performing said domain name resolution operations and preferably said reverse resolution operations. The domain name resolution unit 714 comprises a cache 716 used to at least temporarily store associations between domain names and corresponding IP addresses, obtained by virtue of information transmitted by one or more external name servers 724a, 724b, such as DNS servers.

Thus, when a crisis situation is managed by the orchestrator equipment ORCH 140, the orchestrator equipment ORCH 140 is able to prevent any user equipment UE in a cell affected by said crisis situation from accessing Internet browsing services. It is then sufficient for the orchestrator equipment ORCH 140 to decline the domain name resolution authorization for said user equipment UE that may have requested it from the proxy equipment 710. Outside of the crisis situation or if the crisis situation management rules indicate that said user equipment UE is not limited in terms of Internet browsing at least for said domain name under consideration, the orchestrator equipment ORCH 140 authorizes domain name resolution. The same behavior may be applied in case of reverse resolution.

In one variant embodiment, when a crisis situation is managed by the orchestrator equipment ORCH 140, the orchestrator equipment ORCH 140 may prevent any user equipment UE in a cell affected by said crisis situation from accessing Internet browsing services by using a name resolution to a “honeypot” server. This makes it possible to easily trace these inappropriate name resolution requests and/or to have said server export a web page with a message informing of the blocking of Internet browsing services due to the ongoing crisis situation, while at the same time limiting the exchanges in order to do so.

FIG. 8 schematically illustrates the EPS cellular telecommunications system, according to a particular embodiment of the present invention. FIG. 3 shows various elements already presented with reference to FIG. 1, specifically the PCRF equipment 124, the PGW gateway 125, the orchestrator equipment ORCH 140 and the links 141 and 158. The rest of the EPS cellular telecommunications system does not appear there in order to simplify the diagram.

FIG. 8 further shows an AF (“Application Function”) equipment 830, also called IMS (“IP Multimedia Subsystem”), which is situated outside the scope of the EPC core network portion 120, and which implements an application function. The PCRF equipment 124 is connected to the AF equipment 830 by virtue of a link 812. The interface between the PCRF equipment 124 and the AF equipment 830 is an Rx interface, as defined in the abovementioned 3GPP TS 23.203 specifications.

The layout illustrated in FIG. 8 enables the orchestrator equipment ORCH 140 to intercept, and possibly modify, any message transiting on the links 158 and 812.

The orchestrator equipment ORCH 140 is connected, via a link 820, to a first network equipment (e.g., router or switch) 810 present on the link 812. The orchestrator equipment ORCH 140 is also connected, via a link 821, to a second network equipment (e.g., router or switch) 811 present on the link 158. The first network equipment 810 is configured so as to divert any message transiting on the link 812 to the orchestrator equipment ORCH 140, i.e. on the Rx interface in the context of LTE technology, and the second network equipment 811 is configured so as to divert any message transiting on the link 158 to the orchestrator equipment ORCH 140, i.e. on the Gx interface in the context of LTE technology. For example, the first network equipment 810 and the second network equipment 811 each have a dedicated link with the orchestrator equipment ORCH 140, for example in the form of a tunnel. The first network equipment 810 and the second network equipment 811 encapsulate and then transmit any incoming message via their respective tunnels. The first network equipment 810 and the second network equipment 811 decapsulate any message from their respective tunnels and propagate it as if the message had not been diverted.

Another preferred approach is to spoof the IP address of the PCRF equipment 124 to the PGW gateway 125, to spoof the IP address of the PGW gateway 125 to the PCRF equipment 124, and to spoof the IP address of the PCRF equipment 124 to the AF equipment 830, and to spoof the IP address of the AF equipment 830 to the PCRF equipment 124. Specifically, the EPS cellular telecommunications system is such that the PCRF equipment 124 is supposed to have knowledge of the IP address of the PGW gateway 125, and vice versa. In order to be able to intercept the messages on the link 158, the EPS cellular telecommunications system is such that the IP address of the PGW gateway 125 is replaced with the IP address of the orchestrator equipment ORCH 140 for the PCRF equipment 124, and the IP address of the PCRF equipment 124 is replaced with the IP address of the orchestrator equipment ORCH 140 for the PGW gateway 125. The PCRF equipment 124 thus believes that it is exchanging messages with the PGW gateway 125, whereas in fact the PCRF equipment 124 exchanges these messages with the orchestrator equipment ORCH 140. Likewise, the PGW gateway 125 thus believes that it is exchanging messages with the PCRF equipment 124, whereas in fact the PGW gateway 125 exchanges these messages with the orchestrator equipment ORCH 140. Likewise, the EPS cellular telecommunications system is such that the IP address of the AF equipment 830 is replaced with the IP address of the orchestrator equipment ORCH 140 for the PCRF equipment 124, and the IP address of the PCRF equipment 124 is replaced with the IP address of the orchestrator equipment ORCH 140 for the AF equipment 830. The PCRF equipment 124 thus believes that it is exchanging messages with the AF equipment 830 on the link 812, whereas in fact the PCRF equipment 124 exchanges these messages with the orchestrator equipment ORCH 140. Likewise, the AF equipment 830 thus believes that it is exchanging messages with the PCRF equipment 124, whereas in fact the AF equipment 830 exchanges these messages with the orchestrator equipment ORCH 140.

The orchestrator equipment ORCH 140 thus intercepts any message transiting on the links 158 and 812, thus enabling it to modify desired quality of service QoS parameters when setting up radio bearers. This aspect is detailed below with reference to FIGS. 9 and 10 in the context of setting up sessions.

One example of exchanging messages within the EPS cellular telecommunications system in order to perform a session setup, initiated by the user equipment UE 100, is illustrated schematically in FIG. 9.

In a step S901, the user equipment UE 100 initiates an attachment procedure (“attach procedure”) with the eNB base station 111. The eNB base station 111 contacts the MME entity 122, which decides whether or not to authorize the creation of a session for the user equipment UE 100. The MME entity 122 obtains subscription information relating to the user equipment UE 100, selects the SGW gateway 123 as local mobility anchor for the user equipment UE 100, and instructs the SGW gateway 123 to internally create an environment required to support the session for the user equipment UE 100. The SGW gateway 123 then transmits a session creation request message to the PGW gateway 125. This attachment procedure and the transmission of the session creation request message to the PGW gateway 125 are shown schematically by a single arrow (901) in FIG. 9 for the sake of simplification.

In a following step S902, the PGW gateway 125 seeks to initiate a session setup procedure with the PCRF equipment 124. The PGW gateway 125 initiates this procedure by sending a dedicated message on the link 158. In the context of LTE technology, the PGW gateway 125 sends a CCR (“Credit Control Request”) message via the Gx interface. This message contains, in particular, information representative of desired quality of service QoS parameters for said session. Although it is intended for the PCRF equipment 124, this message is intercepted by the orchestrator equipment ORCH 140.

In a step S903, the orchestrator equipment ORCH 140 analyzes, in particular, the information representative of the desired quality of service QoS parameters for said session, which are contained in said intercepted message, and compares them with the crisis situation management rules. The orchestrator equipment ORCH 140 then accordingly decides whether or not said session may be set up, in view of the crisis situation management rules and the conditions under which said session may be set up. In one variant embodiment, the actions described here with reference to step S903 are executed when the PCRF equipment 124 returns, specifically between steps S908 and S909 described below.

If the orchestrator equipment ORCH 140 decides that the session cannot be set up in view of the crisis situation management rules, the orchestrator equipment ORCH 140 rejects the session setup procedure by responding to the PGW gateway 125 instead of the PCRF equipment 124. In the context of LTE technology, the orchestrator equipment ORCH 140 rejects the session setup procedure by sending a CCA message representative of a negative response to the PGW gateway 125 via the Gx interface.

If the orchestrator equipment ORCH 140 decides that said session may be set up in view of the crisis situation management rules, the orchestrator equipment ORCH 140 possibly modifies the information representative of the desired quality of service QoS parameters for said session, which are contained in said intercepted message, in order to adjust them in accordance with the crisis situation management rules. Next, in a step S904, the orchestrator equipment ORCH 140 returns the possibly modified message to the PCRF equipment 124 via the link 158.

When the PCRF equipment 124 receives the session setup procedure initiation message (possibly modified by the orchestrator equipment ORCH 140), the PCRF equipment 124 performs a check with the HSS server 121 that the subscription of the user of the user equipment UE 100 complies with the session to be set up. To this end, the PCRF equipment 124 sends a profile request message to the HSS server 121 in a step S905. The HSS server 121 identifies the user profile in question in a step S906, and draws information therefrom about the subscription of the user of the user equipment UE 100. In a step S907, the PCRF equipment 124 receives, from the HSS server 121, subscription information enabling it to perform said check. If the subscription of the user of the user equipment UE 100 complies with the session to be set up, the PCRF equipment 124 confirms, in step S908, the setup of the session, by sending a dedicated acknowledgement message to the PGW gateway 125 on the link 158. In the context of LTE technology, the PCRF equipment 124 sends a CCA message representative of a positive response via the Gx interface. Although it is intended for the PGW gateway 125, this acknowledgement message is intercepted by the orchestrator equipment ORCH 140. The orchestrator equipment ORCH 140 detects that the intercepted message is an acknowledgement message, which therefore follows a request message that was previously intercepted and that has already been processed by the orchestrator equipment ORCH 140. The orchestrator equipment ORCH 140 may then ascertain whether or not the PCRF equipment 124 has accepted the setup of the session. Specifically, in the event that the PCRF equipment 124 rejects the setup of the session, the PCRF equipment 124 sends a negative response message to the PGW gateway 125, which is also intercepted by the orchestrator equipment ORCH 140. In this case, in the context of LTE technology, the PCRF equipment 124 sends a CCA message representative of a negative response via the Gx interface.

In step S909, the orchestrator equipment ORCH 140 then returns said acknowledgement message to the PGW gateway 125 via the link 158. Said acknowledgement message indicates which quality of service QoS parameters have ultimately been granted.

In a step S910, the PGW gateway 125 implements the resources necessary to set up the session for the user equipment UE 100. In other words, the PGW gateway 125 implements, by virtue of its PCEF component, quality of service policy enforcement operations, in line with the needs of the session in question.

The acknowledgement is then propagated through messages from the PGW gateway 125 to the user equipment UE 100, passing via the SGW gateway 123, the MME entity 122 and the eNB base station 111. This set of operations constitutes an acknowledgement procedure, shown schematically by a single arrow (S911) in FIG. 9 for the sake of simplification.

Next, in a step S912, signaling is implemented between the PGW gateway 125 and the user equipment UE 100. Then, in an optional step S913, the PGW gateway 125 transmits an acknowledgement message to the PCRF equipment 124 via the link 158, in order to inform it that the setup of the session in question has finished. In the context of LTE technology, this acknowledgement message is a CCR message transmitted via the Gx interface. Although it is intended for the PCRF equipment 124, this acknowledgement message is intercepted by the orchestrator equipment ORCH 140. The orchestrator equipment ORCH 140 detects that the intercepted message is an acknowledgement message, which therefore follows a request message that was previously intercepted and that has already been processed by the orchestrator equipment ORCH 140. The orchestrator equipment ORCH 140 may then ascertain whether or not the setup of the session in question has finished correctly. Finally, in a step S914, the orchestrator equipment ORCH 140 then returns said acknowledgement message to the PCRF equipment 124 via the link 158.

It should also be noted that CCR message sending may be emulated by the orchestrator equipment ORCH 140 to one or more radio bearers of a previously set-up session, in order to enforce a crisis situation management rule. The orchestrator equipment ORCH 140 sends such a CCR message to the PGW gateway 125 by masquerading as the PCRF equipment 124, and does so in order to reduce the quality of service QoS associated with each radio bearer affected during the crisis situation. The orchestrator equipment ORCH 140 preferably keeps track, e.g., in a dedicated table, of the applied quality of service QoS reductions, so as to be able to restore the original quality of service QoS at the end of the crisis situation. This restoration of the original quality of service QoS is also achieved by emulating sending of a CCR message in place of the PCRF equipment 124.

It should also be noted that a radio bearer setup may also be initiated by the AF equipment 830, more particularly for a user equipment UE already attached to the EPS cellular communications system. A corresponding example of message exchanges is illustrated schematically in FIG. 10.

In a step S1051, the AF equipment 830 initiates a session setup procedure with the PCRF equipment 124. The AF equipment 830 initiates this procedure by sending a dedicated message on the link 812. In the context of LTE technology, this message is an AAR message transmitted via the Rx interface. This message is intercepted by the orchestrator equipment ORCH 140. The orchestrator equipment ORCH 140 analyzes, in particular, the information representative of the desired quality of service QoS parameters for said session, which are contained in said intercepted message, and compares them with the crisis situation management rules. The orchestrator equipment ORCH 140 then accordingly decides whether or not said session may be set up, in view of the crisis situation management rules and the conditions under which said session may be set up.

If the orchestrator equipment ORCH 140 decides that said session cannot be set up in view of the crisis situation management rules, the orchestrator equipment ORCH 140 rejects the session setup procedure by responding to the AF equipment 830 instead of the PCRF equipment 124. In other words, the orchestrator equipment ORCH 140 rejects the session setup procedure by sending a negative response to the AF equipment 830. In the context of LTE technology, this message is an AAA message representative of a negative response and is transmitted via the Rx interface.

If the orchestrator equipment ORCH 140 decides that said session may be set up in view of the crisis situation management rules, the orchestrator equipment ORCH 140 returns the intercepted message to the PCRF equipment 124 in a step S1052.

Upon receipt of this message, in a step S1053, the PCRF equipment 124 accordingly creates a session, after a check on the match between session feature information provided by the AF equipment 830 in said message and the policies provided for the user in question (and therefore in this case the user equipment UE 100).

In a step S1054, the PCRF equipment 124 sends an acknowledgement message to the AF equipment 830 on the link 812. In the context of LTE technology, the PCRF equipment 124 sends an AAA message via the Rx interface. The PCRF equipment 124 thus confirms that the session setup request formulated by the AF equipment 830 has been taken into account. This message is intercepted by the orchestrator equipment ORCH 140. The orchestrator equipment ORCH 140 detects that the intercepted message is an acknowledgement message, which therefore follows a request message that was previously intercepted and that has already been processed by the orchestrator equipment ORCH 140. The orchestrator equipment ORCH 140 may then ascertain whether or not the setup of the session in question has been accepted by the PCRF equipment 124. In a step S1055, the orchestrator equipment ORCH 140 returns the intercepted message to the AF equipment 830.

In a step S1056, the PCRF equipment 124 initiates a session setup procedure with the PGW gateway 125. This procedure is initiated by sending a dedicated message on the link 158. In the context of LTE technology, the PCRF equipment 124 sends an RAR (“Re-Authentication Request”) message via the Gx interface. This message is intercepted by the orchestrator equipment ORCH 140.

Ina step S1057, the orchestrator equipment ORCH 140 analyzes, in particular, the information representative of the desired quality of service QoS parameters for said session, which are contained in said intercepted message, and compares them with the crisis situation management rules. The orchestrator equipment ORCH 140 then accordingly decides whether or not said session may be set up, in view of the crisis situation management rules and the conditions under which said session may be set up.

If the orchestrator equipment ORCH 140 decides that said session cannot be set up in view of the crisis situation management rules, the orchestrator equipment ORCH 140 rejects the session setup procedure by responding to the PCRF equipment 124 instead of the PGW gateway 125. In the context of LTE technology, the orchestrator equipment ORCH 140 rejects the session setup procedure by sending an RAA message representative of a negative response to the PCRF equipment 124 via the Gx interface.

If the orchestrator equipment ORCH 140 decides that said session may be set up in view of the crisis situation management rules, the orchestrator equipment ORCH 140 possibly modifies the information representative of the desired quality of service QoS parameters for said session, which are contained in said intercepted message, in order to adjust them in accordance with the crisis situation management rules. Next, in a step S1058, the orchestrator equipment ORCH 140 returns the message, possibly modified in view of the crisis situation management rules, to the PGW gateway 125 via the link 158.

In a step S1059, the PGW gateway 125 implements the resources necessary to set up the session for the user equipment UE 100. In other words, the PGW gateway 125 implements QoS policy enforcement operations through its PCEF component, in line with the needs of the session in question.

In a step S1060, the PGW gateway 125 sends an acknowledgement message to the PCRF equipment 124 via the link 158 to confirm the setup of the session. In the context of LTE technology, the PGW gateway 125 sends an RAA message via the Gx interface. Although it is intended for the PCRF equipment 124, this acknowledgement message is intercepted by the orchestrator equipment ORCH 140. The orchestrator equipment ORCH 140 detects that the intercepted message is an acknowledgement message, which therefore follows a request message that was previously intercepted and that has already been processed by the orchestrator equipment ORCH 140. The orchestrator equipment ORCH 140 may then ascertain whether or not the setup of the session has been accepted by the PGW gateway 125. Next, in a step S1061, the orchestrator equipment ORCH 140 returns the message to the PCRF equipment 124.

In a step S1062, the PGW gateway 125 instructs implementation of the session through messages from the PGW gateway 125 to the user equipment UE 100, passing via the SGW gateway 123, the MME entity 122 and the eNB base station 111. This set of operations is shown schematically by a single arrow (1062) in FIG. 10 for the sake of simplification.

Next, in a step S1063, signaling is implemented between the PGW gateway 125 and the user equipment UE 100.

It should be noted that RAR message sending may be emulated by the orchestrator equipment ORCH 140 to one or more radio bearers of a previously set-up session, in order to enforce a crisis situation management rule. The orchestrator equipment ORCH 140 sends such an RAR message to the PCRF equipment 124 by masquerading as an application function, and does so in order to reduce the quality of service QoS associated with each radio bearer affected during the crisis situation. The orchestrator equipment ORCH 140 preferably keeps track, e.g., in a dedicated table, of the applied quality of service QoS reductions, so as to be able to restore the original quality of service QoS at the end of the crisis situation. This restoration of the original quality of service QoS is also achieved by emulating sending of an RAR message to the PCRF equipment 124.

It should be noted that all of the filtering and quality of service QoS adaptation functionalities for the sessions and radio bearers described above are accessible when the orchestrator equipment ORCH 140 is integrated within the EPS telecommunications system with all of the equipment of this system. All of these filtering and quality of service QoS adaptation functionalities for the sessions and radio bearers are also accessible if the orchestrator equipment is integrated within the infrastructure of a mobile virtual network operator MVNO. A mobile virtual network operator MVNO is a mobile telephony operator that does not have a frequency spectrum concession or a radio infrastructure, but that has agreements with a domestic mobile network operator MNO (“Mobile Network Operator”) to use the network coverage of this domestic mobile operator MNO and provide its own user equipment identifiers, e.g., IMSIs (through its own SIM (“Subscriber Identity Module”) cards), on the network of the domestic mobile network operator MNO.

Thus, in one embodiment of the invention, the mobile virtual network operator MVNO may have all the equipment and functionalities of a mobile network operator MNO, except for the network coverage and the radio infrastructures. Reference is then made to a “full MVNO” operator. It thus has its own equipment, in particular a PGW gateway, a PCRF equipment, an HSS equipment, to manage its own fleet of user equipment UE deployed on the infrastructure of the mobile network operator MNO. In this embodiment of the invention, the equipment of the EPS telecommunications system of the mobile network operator is configured so as to be connected to the equipment of the mobile virtual network operator MVNO. In particular, according to this embodiment, the SGW equipment 123 of the mobile network operator MNO is connected to the PGW gateway of the mobile virtual network operator MVNO via an S8 link in LTE, the MME equipment 122 of the mobile network operator MNO is connected to the HSS equipment of the mobile virtual network operator MVNO via an S6 link in LTE and the PCRF equipment 124 of the mobile network operator MNO is connected to the PCRF equipment of the mobile virtual network operator MVNO via an S9 link in LTE. The orchestrator equipment ORCH 140, integrated into the infrastructure of the mobile virtual network operator MVNO, is thus able to communicate with the equipment of the mobile network operator MNO as if the orchestrator equipment ORCH 140 were integrated directly into the EPS cellular telecommunications system of said mobile network operator MNO. It is therefore able to implement all of the filtering and quality of service QoS adaptation functionalities for the sessions and radio bearers described above.

In an alternative embodiment of the invention, the mobile virtual network operator MVNO has only limited access to the resources of the mobile network operator MNO, the latter only giving it access for example to the interface, e.g., the SGi interface, between the PGW gateway of the mobile network operator MNO and the PDN network of the mobile virtual network operator MVNO and therefore the orchestrator equipment ORCH 140. The orchestrator equipment ORCH 140 is thus able to communicate with the PGW gateway 125 as if the orchestrator equipment ORCH 140 were integrated directly into the EPS cellular telecommunications system of said mobile network operator MNO. The orchestrator equipment ORCH 140 may then decline to set up radio bearers for a particular user equipment UE. According to this alternative embodiment of the invention, the orchestrator equipment ORCH 140 may also potentially reduce the quality of service of one or more radio bearers by intervening with the PCRF equipment 124 by emulating the sending of instructions from an application function AF.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-15. (canceled)

16. A method for accessing services of a cellular telecommunications system comprising:
a radio access portion enabling user equipment to access services of the cellular telecommunications system for which radio bearers have to be set up; and
a core network portion comprising a quality of service policy control equipment connected to a gateway via which said radio bearers are set up in order to access said services;
wherein the method is executed by an orchestrator equipment connected to said gateway and the method comprises:
receiving regular reports from said gateway relating to the radio bearers set up in the cellular telecommunications system for the user equipment attached to said gateway;
detecting occurrence of a crisis situation;
identifying cells of the cellular telecommunications system affected by the crisis situation;
applying, during the crisis situation, crisis situation management rules:
by declining to authenticate user equipment for which the crisis situation management rules indicate that access to said services is barred during the crisis situation, when said gateway makes an authentication request for said user equipment to the orchestrator equipment; and
by asking the gateway to close any session set up for user equipment for which the crisis situation management rules indicate that access to said services is barred during the crisis situation, when the regular reports indicate that such sessions exist for said user equipment.

17. The method according to claim 16, wherein the orchestrator equipment applies the crisis situation management rules during the crisis situation further:
by declining to authenticate user equipment for which the crisis situation management rules indicate that attachment to a predefined access point name is barred during the crisis situation, when said gateway makes an authentication request for said user equipment to the orchestrator equipment; and
by asking the gateway to close any session set up for user equipment for which the crisis situation management rules indicate that attachment to a predefined access point name is barred during the crisis situation, when the regular reports indicate that such sessions exist for said user equipment.

18. The method according to claim 16, wherein the orchestrator equipment applies the crisis situation management rules during the crisis situation further:
by declining to set up said radio bearer of the user equipment when the crisis situation management rules indicate that a quality of service class identifier of said radio bearer is barred during the crisis situation.

19. The method according to claim 16, wherein the orchestrator equipment applies the crisis situation management rules during the crisis situation further:
by asking the gateway to close any radio bearer set up for user equipment for which the crisis situation management rules indicate that a quality of service class identifier is barred, when the regular reports indicate that such sessions exist for said user equipment.

20. The method according to claim 16, wherein the orchestrator equipment applies the crisis situation management rules during the crisis situation further:
by reducing a quality of service associated with session setups by intercepting and modifying messages exchanged during said session setups between the quality of service policy control equipment and said gateway, when the session setups relate to user equipment for which the crisis situation management rules indicate an authorized quality of service limit.

21. The method according to claim 16, wherein the orchestrator equipment applies the crisis situation management rules during the crisis situation further:
by reducing a quality of service associated with previously set-up radio bearers, by emulating messages transmitted by the quality of service policy control equipment to said gateway, when said radio bearers relate to user equipment for which the crisis situation management rules indicate an authorized quality of service limit.

22. The method according to claim 16, wherein the orchestrator equipment applies the crisis situation management rules during the crisis situation further:
by reducing a quality of service associated with radio bearer setups by intercepting and modifying messages exchanged during said radio bearer setups between the quality of service policy control equipment and an application function, when the radio bearer setups relate to user equipment for which the crisis situation management rules indicate an authorized quality of service limit.

23. The method according to claim 16, wherein the orchestrator equipment further applies the crisis situation management rules during the crisis situation:
by reducing a quality of service associated with previously set-up radio bearers, by emulating messages transmitted by an application function to the quality of service policy control equipment, when said radio bearers relate to user equipment for which the crisis situation management rules indicate an authorized quality of service limit.

24. The method according to claim 16,
wherein the orchestrator equipment declares a proxy equipment as a domain name server to said gateway,
wherein the orchestrator equipment serves as authentication and authorization server with the proxy equipment for domain name resolution requests made to the proxy equipment, and
wherein the orchestrator equipment declines to authenticate or authorize user equipment for which the crisis situation management rules indicate that a domain name to be resolved is barred during the crisis situation for said user equipment.

25. The method according to claim 16, wherein the orchestrator equipment implements filtering of at least one level, format least one of:
a user equipment identifier filtering table for which at least one rule may be applied during the crisis situation to the user equipment in question;
a cell identifier filtering table for which at least one rule may be applied during the crisis situation to the cell in question from among the cells affected by the crisis situation;
an access point name filtering table for which at least one rule may be applied during the crisis situation for any connection to the access point name in question; or
a quality of service class identifier filtering table for which at least one associated rule may be applied during the crisis situation for any radio bearer associated with said quality of service class;
a filtering table of an application service for which at least one associated rule may be applied during the crisis situation for any access to said application service; or
a modification table for a quality of service parameter for which at least one associated rule may be applied during the crisis situation for any radio bearer associated with the quality of service parameter in question.

26. The method according to claim 16, wherein the orchestrator equipment comprises a user interface configured to enable a human operator to declare the occurrence of the crisis situation, to identify cells of the cellular telecommunications system affected by the crisis situation, to select at least one user equipment or group of user equipment liable to intervene in the affected cells in order to resolve the crisis situation, and to associate sets of crisis situation management rules with said at least one user equipment or group of user equipment.

27. The method according to claim 26, wherein the user interface is further designed to enable the human operator to define a set of rules for any other user equipment that does not belong to said at least one user equipment or group of user equipment.

28. A non-transitory information storage medium on which there is stored a computer program product comprising instructions that cause an orchestrator equipment to implement the method according to claim 16 when the instructions are read and executed by a processor of the orchestrator equipment.

29. An orchestrator equipment in a context of accessing services of a cellular telecommunications system comprising:
a radio access portion enabling user equipment to access services of the cellular telecommunications system for which radio bearers have to be set up; and
a core network portion comprising a quality of service policy control equipment connected to a gateway via which said radio bearers are set up in order to access said services;
wherein the orchestrator equipment is configured to be connected to said gateway, and the orchestrator equipment comprises electronics circuitry configured for:
receiving regular reports from said gateway relating to the radio bearers set up in the cellular telecommunications system for the user equipment attached to said gateway;
detecting occurrence of a crisis situation;
identifying cells of the cellular telecommunications system affected by the crisis situation;
applying, during the crisis situation, crisis situation management rules:
by declining to authenticate user equipment for which the crisis situation management rules indicate that access to said services is barred during the crisis situation, when said gateway makes an authentication request for said user equipment to the orchestrator equipment; and
by asking the gateway to close any session set up for user equipment for which the crisis situation management rules indicate that access to said services is barred during the crisis situation, when the regular reports indicate that such sessions exist for said user equipment.
